(19) United States
(12) Patent Application Publication
(10) Pub. No.: US 2014/0220533 A1
(43) Pub. Date: Aug. 7, 2014

(54) METHOD OF DISPLAYING ELECTROMAGNETIC FIELD IN HYDROGEN ATOM

(71) Applicant: Haruo MATSUSHIMA, Yamatokooriyama-shi (JP)

(72) Inventor: Haruo MATSUSHIMA, Yamatokooriyama-shi (JP)

(21) Appl. No.: 14/162,844

(22) Filed: Jan. 24, 2014

(30) Foreign Application Priority Data
Feb. 4, 2013 (JP) 2013-32558

(51) Int. Cl. G09B 23/26

(52) U.S. Cl. CPC G09B 23/26
USPC 434/278

(57) ABSTRACT

The method assumes that a single solution or addition or subtraction of solutions of Schrodinger equation represented by polar or parabolic coordinates having its maximum value at the origin gives a wave function and an electric potential of a hydrogen atom. The method further: (1) regards the result of applying a gradient vector operation and thereafter a sign inversion to the wave function as an electric field; regards segments connected successively along the direction of the electric field as electric lines of force; and draws the electric lines of force so as to be approximately proportional in number to the percentage of the wave function with a difference between the maximum and minimum values of the wave function regarded as 100; and (2) displaying the wave function as an electric potential in a contour drawing.

### CROSS-REFERENCE STATEMENT

This application is based on Japanese patent application serial No. 2013-32558, filed with Japan Patent Office on Feb. 4, 2013. The content of the application is hereby incorporated by reference.

### BACKGROUND OF THE INVENTION

1. Field of the Invention

The present invention relates to an improvement in displaying an electromagnetic field in a hydrogen atom as a scientific educational tool.

2. Description of Related Art

There are known US2010/0028840A1 (hereinafter referred to as Patent Document 1) and US2012/0202182A1 (hereinafter referred to as Patent Document 2) as documents disclosing conventional methods of displaying an internal electromagnetic field as a structure of a hydrogen atom.

FIG. 1 of Patent Document 2, which is shown in FIG. 11 herein, shows electric lines of force 1 as an electric field on a vertical plane of a 2pz orbital. The electric lines of force 1, however, extend upward from the coordinate origin placed at the center of the figure, gradually turn 180 degrees in a shape of arc, and finally return to the origin from underneath thereof. Assuming that a proton having a positive electric charge exists at the origin and an electron having a negative electric charge is in oval motion around the proton, all electric lines of force 1 should extend outward from the origin. In the first place, if the wave function of a hydrogen atom is an electric potential 3 as the document asserts, the wave function should have its maximum value at the origin. To the contrary, the wave function of a 2pz orbital (shown in formula 6 later for reference) has its maximum value at the point where r=2a₀, θ=0. In a manner of speaking, the wave function of a p-orbital itself shows that a wave function is not an electric potential.

Further, the magnetic field, which infinitely diverges at r=0, is also inappropriate as the result of analysis of physical phenomenon. The magnetic field of a is orbital is, for example, expressed by H=(1/r−1/a₀)exp(−r/a₀)i_{φ}.

### BRIEF SUMMARY OF THE INVENTION

The present invention solves the above-mentioned conventional problem and provides an electric field or electric lines of force 1 consistent with physical law even in a p orbital. At the same time, the present invention improves an internal structure of a hydrogen atom as an educational tool so as to be more easily understandable. The present invention further provides an internal structure expressed by magnetic lines of force 2 that are derived from a solution converging into a finite value in the whole area from r=0 to infinity, as a magnetic field in orbitals even including an s orbital.

One embodiment of the present invention, to achieve the above-mentioned object, is a method of displaying an electric field in a hydrogen atom. The method assumes that a wave function of a p orbital is given by the wave function having its maximum value at the origin and selected from those obtained by (1) a single solution directly derived from Schrodinger equation and (2) addition or subtraction of a plurality of solutions (the basis thereof will be explained later). An electric field is obtained by a gradient vector operation applied to a wave function and a sign inversion to the result of the vector operation. The method displays the electric field by electric lines of force each of which consists of segments connected successively along the direction of the electric field and which are approximately proportional in number to the percentage of the wave function with a difference between the maximum and minimum values of the wave function being regarded as 100. The method further regards as a magnetic field a result that converges in the whole area of variables and is obtained by multiplying a wave function related to any of orbitals including an s oribital with a metric coefficient and a unit vector along one direction of curvilinear coordinates representing the wave function, and applying a rotational vector operation to the result of the multiplication. The method draws segments connected successively along the direction of the magnetic field as magnetic lines of force 2. For example, a metric coefficient is r, and a unit vector is i_{θ} for a θ-direction in polar coordinates (r, θ, φ).

Since the method of displaying an electromagnetic field in a hydrogen atom according to the embodiment of the present invention adopts as a wave function of a p orbital a wave function that has its maximum value at the origin, electric fields obtained by a gradient vector operation applied to a wave function and a sign inversion applied thereafter and corresponding electric lines of force 1 all extend outwardly from the origin. Further, since electric lines of force 1 almost proportional in number to the value of a wave function are displayed, an equivalent dispersive distribution of a negative electric charge held by an electron (to be described in detail later) will easily be understood. In addition, a magnetic field obtained by multiplying r and i_{θ} to a wave function including one for an s orbital, and applying a rotational vector operation to the result of the multiplication converges into finite values in a whole area along a radial direction. Formulas 13 and 14 shown later should be referred to. Thus, the method solves the problem to be solved by the present invention, enables the distribution of an internal electromagnetic field to be seen, enables the internal structure of an atom to be inferred from the dispersive distribution of the negative electric charge of an electron, is therefore useful in phenomenon analysis, and inspires interest in studying science.

### BRIEF DESCRIPTION OF THE DRAWINGS

FIG. 1 is a vertical cross-sectional view showing electric lines of force 1 of a 2pz orbital of a hydrogen atom according to a first embodiment of the present invention;

FIG. 2 is a contour drawing on the same cross-section as that in FIG. 1 showing an electric potential 3 of a 2pz orbital according to a second embodiment of the present invention;

FIG. 3 is a horizontal cross-sectional view showing electric lines of force 1 of a 2px orbital of a hydrogen atom according to the first embodiment of the present invention;

FIG. 4 is a contour drawing on the same cross-section as that in FIG. 3 showing an electric potential 3 of a 2px orbital according to the second embodiment of the present invention;

FIG. 5 is a view on any cross-section passing through the origin showing electric lines of force 1 of a is orbital of a hydrogen atom according to the first embodiment of the present invention;

FIG. 6 is a contour drawing on the same cross-section as that in FIG. 5 showing an electric potential 3 of a is orbital according to the second embodiment of the present invention;

FIG. 7 is a view on any cross-section passing through the origin showing electric lines of force 1 of a 2s orbital of a hydrogen atom according to the first embodiment of the present invention;

FIG. 8 is a contour drawing on the same cross-section as that in FIG. 7 showing an electric potential 3 of a 2s orbital according to the second embodiment of the present invention;

FIG. 9 is a horizontal cross-sectional view showing magnetic lines of force 2 of a is orbital of a hydrogen atom according to a third embodiment of the present invention;

FIG. 10 is a horizontal cross-sectional view showing magnetic lines of force 2 of a 2px orbital of a hydrogen atom according to the third embodiment of the present invention;

FIG. 11 is a vertical cross-sectional view showing electric lines of force 1 of a 2pz orbital according to a conventional technique;

FIG. 12 is a perspective view showing electric lines of force 1 and magnetic lines of force 2 of a is orbital according to a conventional technique;

FIG. 13 is a plan view showing electric lines of force 1 generated around a single and positive electric charge according to a conventional technique;

FIG. 14 is a plan view showing electric lines of force 1 generated around an electric dipole moment according to a conventional technique; and

FIG. 15A is a view explaining the result of multiplying a unit vector i_{θ} by a wave function to express a standing wave moving in a θ-direction.

FIG. 15B is a view explaining the result of multiplying a metric coefficient r in addition to the unit vector by a wave function to express a standing wave moving in a θ-direction.

### DESCRIPTION OF THE PREFERRED EMBODIMENTS

Hereinafter, preferred embodiments of the present invention will be described with reference to the accompanying drawings. For a hydrogen atom, only 4 orbitals, i.e. 1s, 2s, 2pz, and 2px, which are in the ascending order of energy, will be described herein. The reason why the description will be limited to the four orbitals is that the general feature of the method is fully shown by the four, and in addition, higher-order orbitals are so complicated that the feature thereof can hardly be expressed. At first, two set of parabolic coordinates are restricted to one. The parabolic coordinates (ξ, n, φ) used herein have relations shown below with polar coordinates (r, θ, φ) and orthogonal coordinates (x, y, z).

x=(ξη)^{1/2} cos φ,y=(ξη)^{1/2} sin φ,z=(η−ξ)/2

ξ=r(1−cos θ)=r−z,η=r(1+cos θ)=r+z,φ=φ (1)

A wave function for each orbital used in the present invention is not necessarily the same as those in conventional techniques. First, the solution directly derived from Schrodinger equation is expressed as follows. A function uₙₗₘ(r, θ, φ) is a polar coordinate representation of a direct solution where suffixes nlm (such as 100) are principal (n), azimuthal (l) and magnetic (m) quantum numbers in this order. A function uₙₙₘ(ξ, n, φ) is a parabolic coordinate representation of a direct solution where suffixes n₁, n₂, m (such as 100) are parabolic (n₁ and n₂) and magnetic (m) quantum numbers.

Since the polar coordinate representation of a direct solution is a wave function of each orbital in conventional techniques, the both are named as a wave function. The name “wave function” is herein restricted to a wave function of each orbital and distinguished from “direct solution” for convenience. Hereinafter, wave functions of the four orbitals are expressed by Ψ₁ₛ, Ψ₂ₛ, Ψ_{2pz}, and Ψ₂ₚₓ in this order. The combination of direct solutions expressing each wave function is shown below in the two coordinates in a comparing manner. Normalization coefficients are omitted because of being dispensable. A coefficient a₀ is Bohr radius. Bold and italic characters represent vectors.

$$\begin{matrix}1 s orbital & \\ \begin{matrix}{Ψ}_{1 s} = {u}_{100} ( r , θ , φ ) \\ = exp ( - r / {a}_{0} ) \\ = exp \{ - ( ξ + η ) / 2 {a}_{0} \} \\ = {u}_{000} ( ξ , η , φ )\end{matrix} & ( 2 ) \\ 2 s orbital & \\ \begin{matrix}{Ψ}_{2 s} = {u}_{200} ( r , θ , φ ) \\ = ( 2 - r / {a}_{0} ) exp ( - r / 2 {a}_{0} ) \\ = \{ 2 - ( ξ + η ) / 2 {a}_{0} \} exp \{ - ( ξ + η ) / 4 {a}_{0} \} \\ = {u}_{100} ( ξ , η , φ ) + {u}_{010} ( ξ , η , φ )\end{matrix} & ( 3 ) \\ 2 pz orbital & \\ \begin{matrix}{Ψ}_{2 pz} = {u}_{100} ( ξ , η , φ ) \\ = ( 1 - ξ / 2 {a}_{0} ) exp \{ - ( ξ + η ) / 4 {a}_{0} \} \\ = \{ 1 - ( r / 2 {a}_{0} ) ( 1 - cos θ ) \} exp ( - r / 2 {a}_{0} ) \\ = \{ {u}_{200} ( r , θ , φ ) + {u}_{210} ( r , θ , φ ) \} / 2\end{matrix} & ( 4 ) \\ \begin{matrix}{Ψ}_{2 pz} = {u}_{010} ( ξ , η , φ ) \\ = ( 1 - η / 2 {a}_{0} ) exp \{ - ( ξ + η ) / 4 {a}_{0} \} \\ = \{ 1 - ( r / 2 {a}_{0} ) ( 1 - cos θ ) \} exp ( - r / 2 {a}_{0} ) \\ = \{ {u}_{200} ( r , θ , φ ) + {u}_{210} ( r , θ , φ ) \} / 2\end{matrix} & ( 5 ) \\ Conventional 2 pz orbital for reference & \\ \begin{matrix}{u}_{210} ( r , θ , φ ) = ( r / {a}_{0} ) cos θ exp ( - r / 2 {a}_{0} ) \\ = \{ 1 - ( r / 2 {a}_{0} ) + ( r / 2 {a}_{0} ) cos θ - 1 + \\ ( r / 2 {a}_{0} ) + ( r / 2 {a}_{0} ) cos θ \} exp ( - r / 2 {a}_{0} ) \\ = \{ ( 1 - ξ / 2 {a}_{0} ) - ( 1 - η / 2 {a}_{0} ) \} exp \{ - ( ξ + η ) / 4 {a}_{0} \} \\ = {u}_{100} ( ξ , η , φ ) - {u}_{010} ( ξ , η , φ )\end{matrix} & ( 6 ) \\ 2 px orbital & \\ \begin{matrix}{Ψ}_{2 px} = {u}_{200} ( r , θ , φ ) - {u}_{211} ( r , θ , φ ) \\ = \{ ( 2 - r / {a}_{0} ) - ( r / {a}_{0} ) sin θcos φ \} exp ( - r / 2 {a}_{0} ) \\ = \{ 2 - ( ξ + η ) / 2 {a}_{0} - {( ηξ )}^{1 / 2} cos φ / {a}_{0} \} exp \{ - ( ξ + η ) / 4 {a}_{0} \} \\ = {u}_{100} ( ξ , η , φ ) + {u}_{010} ( ξ , η , φ ) - {u}_{001} ( ξ , η , φ )\end{matrix} & ( 7 ) \\ Conventional 2 px orbital for reference & \\ \begin{matrix}{u}_{211} ( r , θ , φ ) = ( r / {a}_{0} ) sin θ cos φexp ( - r / 2 {a}_{0} ) \\ = \{ {( ηξ )}^{1 / 2} / {a}_{0} \} cos φ exp \{ - ( ξ + η ) / 4 {a}_{0} \} \\ = {u}_{001} ( ξ , η , φ )\end{matrix} & ( 8 )\end{matrix}$$

The results obtained by applying a gradient vector operation and a sign inversion to these functions are electric fields. Electric lines of force1 are obtained by plotting the electric field along the direction thereof. A drawing showing distribution obtained from a wave function of a p orbital, which is not disclosed in the prior art documents, is referred to as Embodiment 1. A drawing showing electric lines of force 1 obtained from a wave function of an s orbital, which is disclosed in the prior art documents, but almost proportional in number of lines to the value of the wave function is referred to as Embodiment 2. These wave functions are, as they are, electric potentials 3 which have physical meaning. A perspective illustration of contour lines on each cross-section is referred to as Embodiment 3. Further, a drawing of an electric potential 3 is placed under a drawing of electric lines of force 1 with centers of the two drawings identical in horizontal position so that a relation between the two quantities can be understood from the drawings as an educational tool.

A magnetic field is obtained by multiplying a metric coefficient r and a unit vector i_{θ} in a θ-direction to the above-described wave function, and applying a rotational vector operation to the result of the multiplication. Magnetic lines of force2 are obtained by plotting the magnetic field along the direction thereof. A drawing showing distribution of the magnetic lines of force 2 is referred to as Embodiment 4.

### Example 1

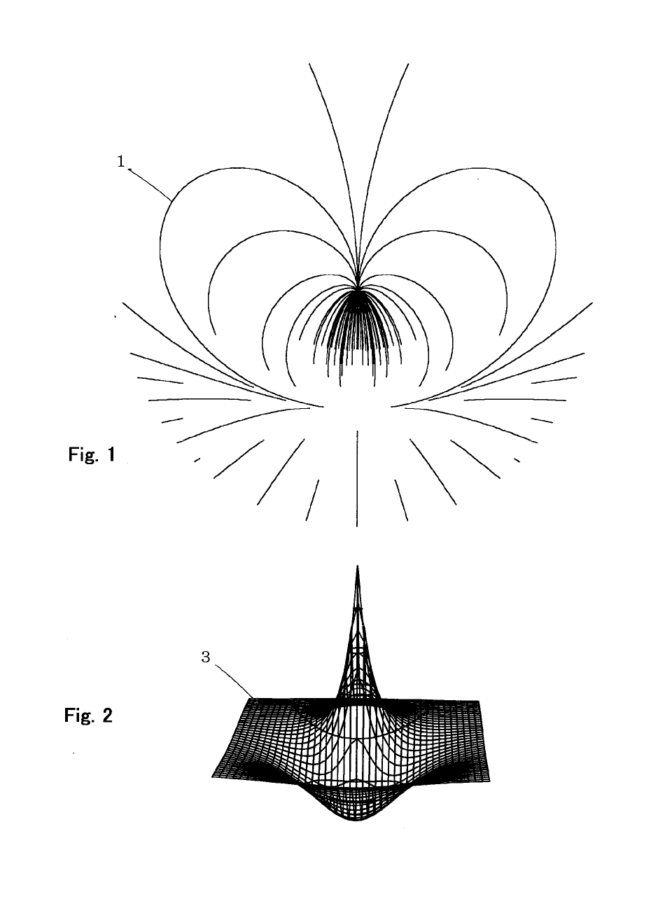

FIG. 1 is a vertical cross-sectional view showing distribution of electric lines of force 1 of a 2pz orbital in a range of a radius 6a₀ obtained by use of electromagnetic field display method for a hydrogen atom as an educational tool according to the first embodiment of the present invention. A following formula is obtained by applying a gradient vector operation and a sign inversion to the wave function Ψ_{2pz} of a 2pz orbital shown in Formula 4.

$$\begin{matrix}E = - grad \{ {u}_{200} ( r , θ , φ ) + {u}_{210} ( r , θ , φ ) \} \\ = \{ ( 2 - cos θ - r / 2 {a}_{0} + r cos θ / 2 {a}_{0} ) {i}_{r} + sin θ {i}_{θ} \} \\ exp ( - r / 2 {a}_{0} ) / 2 {a}_{0}\end{matrix} \qquad ( 9 )$$

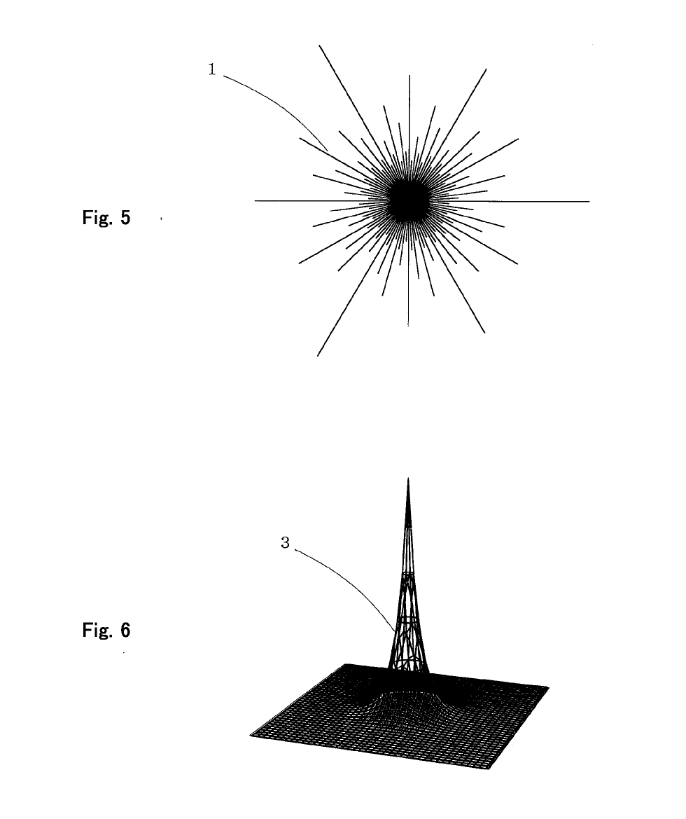

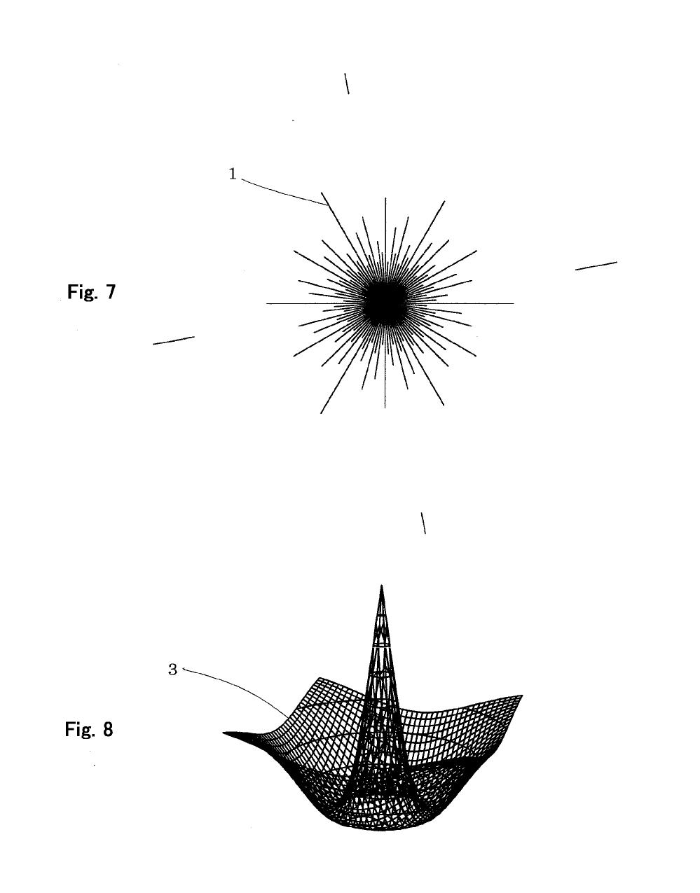

Electric lines of force 1 are drawn by applying a method similar to that disclosed in Patent Document 2 to the result shown in Formula 9. The number of the electric lines of force 1 is made proportional to the percentage of a difference between the maximum and minimum values of the wave function Ψ_{2pz} given by Formula 4, and around 100 lines in total. Since FIG. 1 shows a complicated pattern, and the method of making the electric lines of force 1 proportional to the wave function is also complicated, detailed description thereon is skipped. The method is similar to description given later in relation to FIG. 5 and FIG. 7 which show simple patterns.

### Example 21

FIG. 2 is a contour drawing showing an electric potential 3 of a 2pz orbital obtained by use of an electromagnetic field display method for a hydrogen atom as an educational tool according to the third embodiment of the present invention. Spreadsheet software Excel provided by Microsoft (trademark) was used. Formula 4 representing a wave function of a 2pz orbital was substituted with r=(z²+x²)^{1/2} and r cos θ=z. A row of the matrix of the spreadsheet were filled with z and a column with x in a range from −10a₀ to +10a₀. Each cell as an intersection was filled with (1−r/2−r cos θ/2)exp(−r/2). A contour diagram was drawn for the whole area, and scale marks, references and the like were deleted. The diagram, although being drawn under the condition that y=0 for convenience, shows an electric potential 3 on a vertical cross-section at any of φ. FIG. 2 is placed under FIG. 1 with its center accorded with that of FIG. 1 in horizontal position.

### Example 31

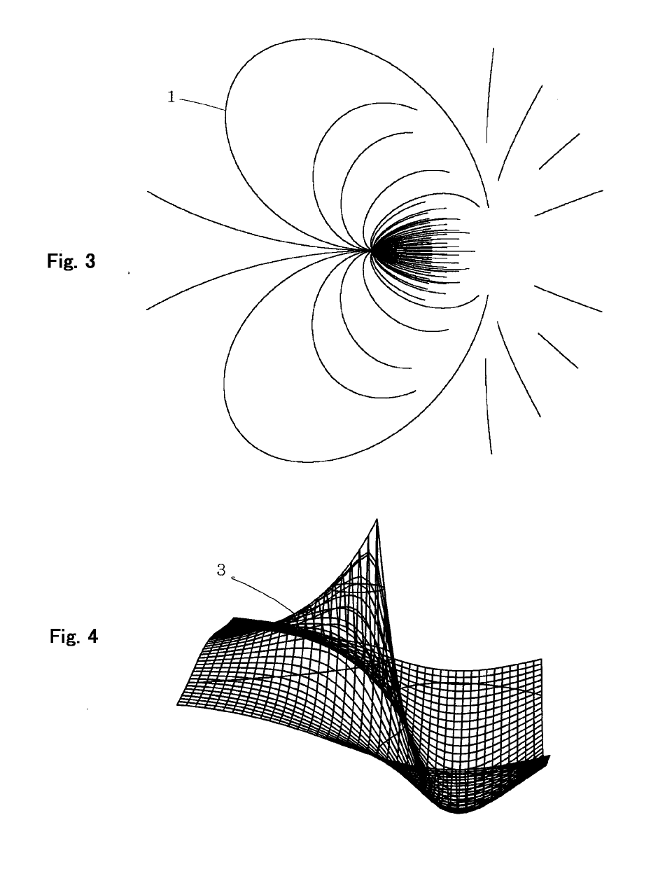

FIG. 3 is a vertical cross-sectional view showing the distribution of electric lines of force 1 of a 2px orbital obtained by an electromagnetic field display method for a hydrogen atom as an educational tool according to the first embodiment of the present invention. FIG. 3 is drawn in the same range of a radius 6a₀ and in the same scale as FIG. 1. A gradient vector operation and a sign inversion were applied to the wave function Ψ₂ₚₓ of a 2px orbital given by Formula 7. An electric field on a vertical cross-section where φ=0 and φ=π is given as follows.

$$\begin{matrix}E = - grad \{ {u}_{200} ( r , θ , φ ) + {u}_{211} ( r , θ , φ ) \} \\ = \{ ( 2 - r / 2 {a}_{0} + sin θ - r sin θ / 2 {a}_{0} ) {i}_{r} + cos θ {i}_{θ} \} \\ exp ( - r / 2 {a}_{0} )\end{matrix} \qquad ( 10 )$$

In the same manner as FIG. 1, the electric lines of force 1 almost proportional in number to the percentage of a difference between the maximum and minimum values of the wave function Ψ₂ₚₓ of a 2px orbital are drawn.

### Example 41

FIG. 4 is a contour drawing on the same vertical cross-section where φ=0 and φ=π as that in FIG. 3, showing an electric potential 3 of the wave function Ψ₂ₚₓ of a 2px orbital given by Formula 7, and obtained by use of electromagnetic field display method for a hydrogen atom as an educational tool according to the third embodiment of the present invention. FIG. 4 was drawn in the same manner as FIG. 2.

### Example 51

FIG. 5 is a view on any cross-section passing through the origin showing electric lines of force 1 of a is orbital obtained by use of electromagnetic field display method for a hydrogen atom as an educational tool according to the second embodiment of the present invention. An electric field E obtained by applying a gradient vector operation and a sign inversion to the wave function Ψ₁ₛ of a is orbital represented by polar coordinates given by Formula 2 is as follows.

E=(1/a₀)exp(−r/a₀)iᵣ (11)

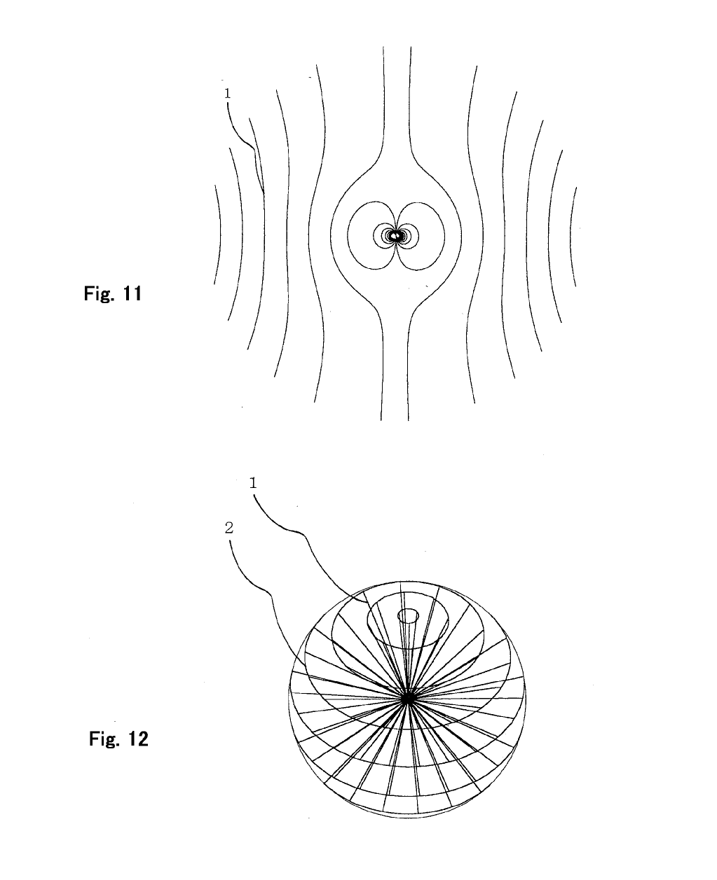

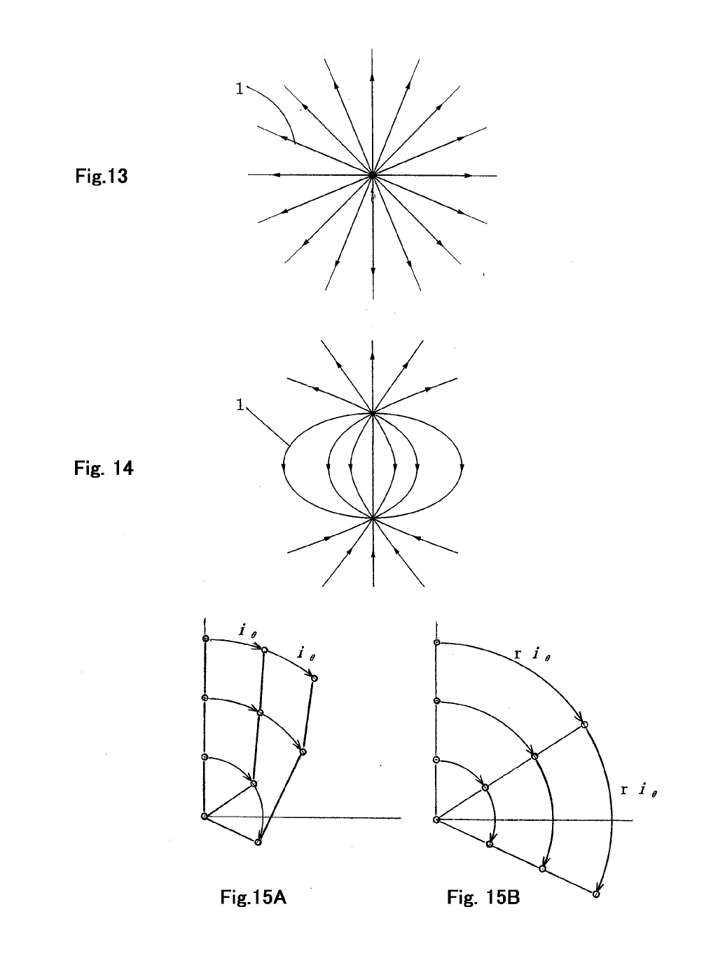

Electric lines of force 1 obtained by Formula 11 are all straight lines extending outwardly from the coordinate origin. However the figure as it is does not largely differ from the conventional one shown in FIG. 12 or electric lines of force generated from a single positive charge shown in FIG. 13 and lacks appeal power as an educational tool. FIG. 5 is, therefore, improved by use of a following method.

The wave function Ψ₁ₛ has the maximum value 1 at r=0, and the minimum value 0 at r=infinity. The percentage with respect to a difference 1 between the maximum and minimum values is calculated. Electric lines of force 1 corresponding to the percentage in number are drawn. Thereafter, sequence shown below follows. (1) Line segments which connect the origin with trisected points on a circle having a radius r=4.605 a₀ where the relation Ψ₁ₛ=1/100 is satisfied are drawn. (2) Line segments which connect the origin with trisected points on a circle having a radius r=3.912 a₀ where the relation Ψ₁ₛ=2/100 is satisfied are drawn at the positions where the intervals of three line segments drawn in the area of 1/100 are bisected. (3) Line segments which connect the origin with points equally dividing into six parts a circle having a radius r=3.2185 a₀ where the relation Ψ₁ₛ=4/100 is satisfied are drawn at the positions where the intervals of six line segments drawn so far are bisected. (4) Line segments which connect the origin with points equally dividing into twelve parts a circle having a radius r=2.525 a₀ where the relation Ψ₁ₛ=8/100 is satisfied are drawn at the positions where the intervals of twelve line segments drawn so far are bisected. (5) Line segments are drawn in the same manner from a circle having a radius r=1.832 a₀ where the relation Ψ₁ₛ=16/100 is satisfied at the positions where the intervals of twenty-four line segments drawn are bisected. In this procedure, one half, i.e. 12, of the 24 line segments are drawn on a circle having a 10% larger radius and other half are drawn on a circle having a 10% smaller radius alternately in an up and down manner. (6) Line segments, 48 in number, to be drawn from a circle having a radius r=1.139 a₀ where Ψ₁ₛ=32/100 is satisfied are drawn on 10% larger and smaller radii alternately in the same manner as (5). Line segments, 96 in total number, obtained by the sequence are drawn in FIG. 5, which shows all the electric lines of force 1 extend from the origin equally dividing angle of 360 degrees around the origin. The lengths of a₀ are set identical between FIGS. 1 and 3.

### Example 61

FIG. 6 is a contour drawing on any cross-section passing through the origin showing an electric potential 3 of the wave function Ψ₁ₛ of a is orbital given by Formula 2, and obtained by use of electromagnetic field display method for a hydrogen atom as an educational tool according to the third embodiment of the present invention. FIG. 6 was drawn in the same manner as FIG. 2, and is placed under FIG. 5 with its center accorded with that of FIG. 5 in horizontal position.

### Example 71

FIG. 7 is a view on any cross-section passing through the origin showing electric lines of force 1 of a 2s orbital obtained by use of electromagnetic field display method for a hydrogen atom as an educational tool according to the first embodiment of the present invention. Electric field E obtained by applying a gradient vector operation and a sign inversion to the wave function Ψ₂ₛ of a 2s orbital represented by polar coordinates given by Formula 3 is given as follows.

E=(2−r/2a₀)exp(−r/2a₀)/a₀iᵣ (12)

Although a drawing method similar to that used for FIG. 5 is also used here, small difference will be described. The wave function Ψ₂ₛ has the maximum value 2 at r=0, and the minimum value, −0.27067, at r=4a₀. A difference between the maximum and minimum values is 2.27067. There are two radii r where the wave function Ψ₂ₛ is equal to a value −0.2479 larger than the minimum value by 1/100 of the difference. The two are r=3.275 and r=4.957. For the former one, a procedure similar to that used for FIG. 5 is applied. For the latter one, line segments positioned on lines connecting the origin with bisected points on a circle having the latter radius and extending up to a radius 6a₀ in a direction opposite to the origin are drawn. Radii r that make Ψ₂ₛ equal to a value −0.2252 larger than the minimum value by 2/100 of the difference are r=3.275 and r=5.468. Two line segments extending from the bisected points on a circle having the latter radius up to a radius 6a₀ are drawn in the intermediate between the two line segments already drawn. Electric lines of force 1 of a 2s orbital will be 100 in number including outer four.

### Example 81

FIG. 8 is a contour drawing on any cross-section passing through the origin showing an electric potential 3 of the wave function Ψ₂ₛ of a 2s orbital given by Formula 3, and obtained by use of electromagnetic field display method for a hydrogen atom as an educational tool according to the third embodiment of the present invention. FIG. 8 was drawn in the same manner as FIG. 2, and is placed under FIG. 7 with its center accorded with that of FIG. 7 in horizontal position.

### Example 91

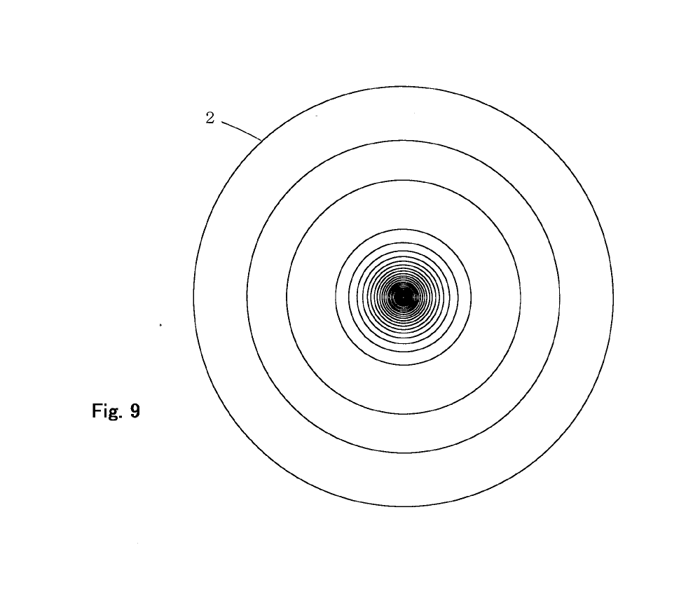

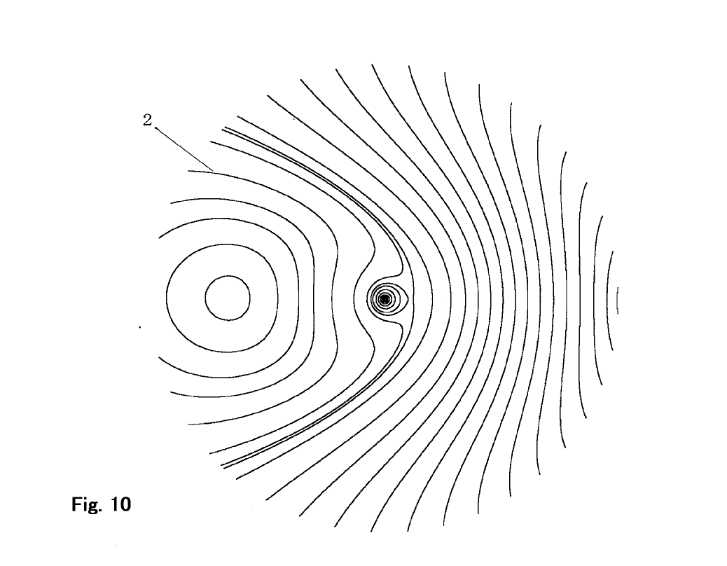

FIG. 9 is a view showing the distribution of magnetic lines of force 2 of a is orbital on a horizontal cross-section obtained by an electromagnetic field display method for a hydrogen atom as an educational tool according to the fourth embodiment of the present invention. Multiplication of a metric coefficient r and a unit vector i_{θ} in a θ-direction to Ψ₁ₛ and application of a rotational vector operation to the result of the multiplication lead to a magnetic field given by a following formula.

H=(2−r/a₀)exp(−r/a₀)i_{φ} (13)

Since the magnetic field H only has a p-component, magnetic lines of force 2 are circular. The magnetic lines of force 2 on a horizontal cross-section where θ=n/2 were drawn in a range from r=0 to r=6a₀ with an interval between nearest lines inversely proportional to the strength of the magnetic field.

### Example 101

FIG. 10 is a view showing the distribution of magnetic lines of force 2 of a 2px orbital on a horizontal cross-section obtained by an electromagnetic field display method for a hydrogen atom as an educational tool according to the fourth embodiment of the present invention. Multiplication of a metric coefficient r and a unit vector i_{θ} in a θ-direction to Ψ₂ₚₓ, application of a rotational vector operation to the result of the multiplication, and substitution of θ=n/2 to the result of the rotational vector operation lead to a magnetic field given by a following formula.

H={i_{φ}(4−4r/a₀+r²/2a₀²+r cos θ(r/2a₀−3)/a₀)−iᵣr sin φ/a₀}exp(−r/2a₀) (14)

Magnetic lines of force 2 on a horizontal cross-section where θ=n/2 were obtained by use of the same method as that disclosed in Patent Document 2, and drawn in a range of a radius r=6a₀.

Hereinafter, supplemental explanation on operation and function of the educational tool formed as described above is given. Solutions of Schrodinger equation have generally been represented by polar coordinates (r, θ, φ), and the solutions directly derived from the equation are regarded as wave functions of respective orbitals as if the solutions were historical heritages. For example, Formula 3 corresponds to a 2s orbital, Formula 6 to a 2pz orbital, and so on. To the contrary, each solution represented by parabolic coordinates is given in the form of addition or subtraction of two solutions so as to be consistent with a function represented by polar coordinates.

However, since direct solutions represented by the two set of coordinates are identical with each other in Formulas 2 and 8, it can not necessarily be said that Schrodinger equation for a hydrogen atom is suited for polar coordinates and not so suited for parabolic coordinates. Therefore, it is herein supposed that there is no superiority or inferiority between the two set of coordinates. The direct solutions related to 2s and 2pz orbitals represented by the two set of coordinates are four of u₂₀₀(r, θ, φ), u₂₁₀(r, θ, φ), u₁₀₀ (ξ, n, φ), and u₀₁₀(ξ, n, φ). Searching for a conclusion where the two set of coordinates are the same in suitability and have no inconsistency arrives at Formulas 3, 4 and 5. More specifically, it is concluded that a wave function of a 2s orbital is given by a direct solution represented by polar coordinates, and that of a 2pz orbital is by a direct solution represented by parabolic coordinates. These wave functions are all have their maximum values at the coordinate origin.

If Formula 8 is reviewed based on a supposition that a direct solution is, as it is, not a wave function of each orbital and any of wave functions of 1s, 2s and 2pz orbitals has its maximum value at the coordinate origin, it can be understood that Formula 7 is adequate as a wave function of a 2px orbital from an analogy with the two examples of Formulas 4 and 5. Formula 7 also has its maximum value at the coordinate origin.

Next, the percentage allocation of the number of electric lines of force 1 will be described. FIG. 12 is taken from FIG. 4 of Patent Document 2. In FIG. 12, electric lines of force 1 are drawn as straight line segments having the same length and extending three-dimensionally, isotropically and outwardly from the origin. FIG. 13 shows electric lines of force 1 generated around a single positive electric charge, which can often be seen in a textbook on electromagnetics. The two drawings, even though being different between perspective and plan views, appear identical with each other in meaning thereof and do not successfully express a difference. In FIG. 13, an electric field E at a position distant by r from a positive electric charge q placed at the origin is given by (¼πε₀)q/r². FIG. 12 is given by Formula 11, i.e., exp (−r/a₀)/a₀.

The definition or nature of electric lines of force 1 may be as follows. (1) Each of electric lines of force is a series of line segments plotting an electric field along the direction thereof. (2) Each of electric lines of force comes out of a positive charge and arrives at a negative charge. (3) The density of electric lines of force 1 is proportional to the strength of an electric field. Among these, if the definition (2) is interpreted precisely, electric lines of force 1 coming out of a single positive electric charge should be drawn to infinite distance. In practice, such electric lines of force are expressed by straight line segments having the same length in a limited space of a textbook and are silently understood. However, since FIG. 12 is a drawing that illustrates Formula 11, it cannot but be said that FIG. 12 is not sufficient as an educational tool and does not express the meaning of Formula 11 at all if being the same as FIG. 13.

The function given by Formula 11 drastically decreases with a radius r in such a manner that the function is 1/100 at r=4.605a₀, 1/1000 at r=6.907a₀, and 1/10000 at r=9.210a₀. An electric field generated by the single positive electric charge does not easily decease with a radius r as being 1/100 at r=10a₀, 1/1000 at r=31.62a₀, and 1/10000 at r=100a₀. This difference is thought to be caused by the definition (2). Electric lines of force 1 generated by a single positive electric charge extend to infinite distance as described above. On the other hand, in a is orbital, negative electric charge is thought to be equivalently distributed near the origin, and therefore, the electric lines of force 1 which are line segments that connect the origin where a positive charge is placed with the negative charge do not further extend therefrom.

The method used for FIG. 5 is nothing but what realizes this form of electric lines of force 1. FIG. 5 means that there are 96 of equivalently distributed negative electric charges in total at respective 96 of end points of straight line segments extending outwardly from the origin on a one-to-one basis. The 96 segments are large in number near the origin and decrease with distance from the origin. This figure can really be said to show the internal structure of a hydrogen atom. Patent Document 2 shows an electric potential 3 and an electric field of a is orbital by formulas, whereas the figure cannot show this structure. Even as to the existing theory of “a wave function=an amplitude of probability,” a sphere-shaped illustration of the existence probability of an electron based on the formula of the theory shown in a textbook also can hardly be said to show the internal structure. The present invention solves the deficiencies in the two theories and shows the internal structure of a hydrogen atom in an easy-to-understand way as an educational tool.

In FIG. 1, the advantageous results are more apparent. Without the percentage allocation, the entire electric lines of force 1 drawn in FIG. 1 will reach a point of (r, θ)=(3, π) in accordance with the definition (1) and concentrate at the point with high density. This situation will easily be inferred from FIG. 1 as it is. If the electric lines of force 1 are drawn more extensively up to a point (3, π), entire electric lines of force 1 will connect the point with the origin and will be similar to those in FIG. 14. FIG. 14 is a view showing electric lines of force 1 of an electric dipole moment as described widely in textbooks. An electric field generated by the negative electric charge of the electric dipole moment is only given by FIG. 13 with its positive electric charge converted into a negative one, and therefore, is close to negative infinity near the negative charge resulting in concentration of electric lines of force 1 with high density. However, at the point of (3, π) in FIG. 1, an electric field is zero, and therefore, electric lines of force 1 should also be zero according to the nature (3). For this purpose, the concentrated electric lines of force 1 should be cut off at somewhere in the middle thereof. It is determined by percentage where to cut off the electric lines of force 1.

The electric dipole moment shown in FIG. 14 meets all the natures (1) through (3) of electric lines of force 1. However, in the case of FIG. 1, the nature (2) is not met because neither quantity nor position of the negative electric charge is known. Therefore, the number of electric lines of force 1 is allotted by percentage to make the density of the electric lines of force 1 proportional to the height of an electric potential 3 by interpreting the nature (3) positively. As a result, the electric lines of force 1 are cut off in the middle thereof. Each of the cut-off edges gives an image of the existence of a negative electric charge according to the nature (2). In fact, it is well understood from FIG. 1 that the divided electrons are concentrated around the point (3, n), especially on the side of the origin. If the whole electric lines of force 1 extend from the origin equally dividing angle of 360 degrees around the origin in the similar manner for FIG. 5, the electric lines of force 1 will further be concentrated around the point (3, n) and blank will be widen in an area above the origin, which will make the whole image hard to understand. Therefore, many of electric lines of force 1 were daringly allotted in the area.

Next, a contour drawing of an electric potential 3 as the third embodiment will be described. Patent Document 2 discloses the theory that a wave function is an electric potential 3, whereas fails to treat the drawings as educational tools. FIGS. 2, 4, 6 and 8 according to embodiments of the present invention express electric potentials 3 as physical quantities by three-dimensional contour diagrams. In addition, each of the figures is placed in vertically parallel with a corresponding figure of electric lines of force 1 in a comparable way. Therefore, the relation between the two is well understood. It is also well understood that the gradient of an electric potential 3 is an electric field and line segments plotting an electric field along the direction thereof are electric lines of force 1.

Next, a magnetic field will be described. Movement of an electric charge, in general, generates a magnetic field, and therefore, it is not in doubt that an electron revolving around a proton generates a magnetic field. However, since the revolving movement itself is unknown and it should be understood from a statistical view point that clockwise and anti-clockwise movements occur in the same occasion, magnetic fields corresponding to the two movements are compensated with each other. Even if a standing wave formed by an electron as a wave is represented by a wave function as generally considered, the standing wave does not absolutely still. The whole things existing in the nature cannot avoid unstable movement called float or fluctuation. Especially, the revolution direction of an electron can be seen the most unstable. What is unstable may be a position. The shape may be a movement kept unchanged. The standing wave generates a magnetic field because of having an electric charge.

Patent Documents 1 and 2, simply multiplies a unit vector i_{θ} to a wave function to express that a standing wave moves in a θ-direction. To the contrary, the present invention multiplies a metric coefficient r in addition to the unit vector. FIG. 15A and FIG. 15B show the difference in the result between multiplication and no multiplication of the metric coefficient r. FIG. 15A shows the result obtained by only multiplying i_{θ}, and FIG. 15B shows that by multiplying r i_{θ}. FIG. 15A and FIG. 15B show traces of points (shown by small black circles) placed at the positions of r=0, 1, 2 and 3 on a z-axis, moved in a θ-direction by a unit distance, i.e., on a circle by 1 in distance, and subsequently further moved by a unit distance. On FIG. 15A, each point revolves along a corresponding circle by a distance of 1 irrespective of a distance r, resulting in deformation in relationship between the points. On the other hand, on FIG. 15B, each point revolves along a corresponding circle by a distance proportional to a distance r. As a result, relationship between points is maintained.

A metric coefficient being 1 in an r-direction and r sin θ in a φ-direction emerges not only in the aforementioned gradient and rotational vector operations but also in an infinite small movement. Infinite small distances in r, θ and φ-directions are dr, r dθ and r sin θ dφ, respectively. Thus, a metric coefficient is inevitable for handling of curvilinear coordinates, such as polar coordinates. Prior Patent Documents 1 and 2 failed to consider this necessary element in spite of handling curvilinear coordinates. The present invention has introduced a metric coefficient as the necessary element, and as a result, solved the problem of divergence at the origin.

What is described above is summarized as follows. The embodiments of the present invention have shown, as a premise, that a wave function of a p orbital has its maximum value at the origin, and further: (1) regarded the result of a gradient vector operation and thereafter a sign inversion applied to a wave function of each orbital including an s orbital as an electric field, regarded line segments connected along the direction of the electric field as electric lines of force1, allotted about 100 for the electric lines of force according to the percentage the wave function with respect to a difference between the maximum and minimum values of the wave function, and as a result, successfully displayed the internal structure of an electron since 100 of the electric lines of force are inevitably cut off in the middle thereof and the cut-off edges give an image of the existence of an electron divided into equivalently distributed electric charges from the nature of electric lines of force coming out of a positive electric charge and reaching a negative electric charge; (2) displayed a wave function as a physical quantity and an electric potential 3 by a contour drawing, in addition, arranged the contour drawing in vertically parallel to the drawing of a corresponding electric lines of force 1, and as a result, successfully explained the relation between the two; and (3) regarded the result of multiplying a metric coefficient and a unit vector in a revolving direction to a wave function and applying a rotational vector operation to the result of the multiplication as a magnetic field, drawn the result of plotting the magnetic field as magnetic lines of force 2, and as a result, successfully expressed the internal structure of an atom.

The number of the electric lines of force 1 in the above-mentioned feature (1) is not limited to 100, but can be 1000 for larger and finer drawings. There can also be considered such a method that the length and angle of electric lines of force 1 are determined based on random number, and the distribution of the lengths is determined based on the value of a wave function. The contour drawing in the feature (2) is not limited to a three-dimensional one, but can be a planer drawing, as a matter of course. Electric lines of force 1 drawn on a contour planer drawing of electric potential 3 in a superposing manner will facilitate the understanding of a relation between the two. Software is not limited to Microsoft Excel (trademark), but other software can be used. Although examples for the features (1) through (3), all give cross-sectional views and only draw one of electric and magnetic fields, variations, such as a simultaneous or combinatory drawing of both electric and magnetic fields, and a three-dimensional view can easily be devised.

As described above, the embodiments of the present invention successfully display the internal structure of an atom which has not been seen, and not only inspire an interest in science, especially quantum mechanics, and prevent educands from going away from science, but also help prevent their misunderstanding that can be caused by inference weighted only in mathematics from occurring.

### INDUSTRIAL APPLICABILITY

A method of displaying an electromagnetic field in a hydrogen atom as an educational tool according to the present invention visualizes the figure of a hydrogen atom, enables educands to have a close feeling toward hardly understood or approached quantum mechanics, prevents them from going away from science, and is therefore useful for education and research.

What is claimed is:

1. A method of displaying an electromagnetic field in a hydrogen atom, comprising:
regarding a result of applying a gradient vector operation to a wave function of any other orbital than an s orbital of a hydrogen atom, and applying a sign inversion to a result of the vector operation as an electric field; and
drawing electric lines of force each consisting of line segments connected successively along a direction of the electric field, the electric lines of force being approximately proportional in number to the percentage of the wave function with a difference between maximum and minimum values of the wave function regarded as 100.

2. A method of displaying an electromagnetic field in a hydrogen atom, comprising:
regarding a result of applying a gradient vector operation to a wave function of any of orbitals of a hydrogen atom, and applying a sign inversion to a result of the vector operation as an electric field; and
drawing electric lines of force each consisting of line segments connected successively along a direction of the electric field, the electric lines of force being approximately proportional in number to the percentage of the wave function with a difference between maximum and minimum values of the wave function regarded as 100.

3. A method of displaying an electromagnetic field in a hydrogen atom, comprising:
regarding a wave function of any other orbital than an s orbital of a hydrogen atom as an electric potential; and
displaying the electric potential in a contour drawing.

4. A method of displaying an electromagnetic field in a hydrogen atom, comprising:
regarding a wave function of any of orbitals of a hydrogen atom as an electric potential; and
displaying the electric potential in a contour drawing.

5. A method of displaying an electromagnetic field in a hydrogen atom, comprising:
regarding a result of multiplying, to a wave function of any of orbitals of a hydrogen atom, a metric coefficient and a unit vector along one direction of curvilinear coordinates representing the wave function, and applying a rotational vector operation to a result of the multiplication as a magnetic field; and
drawing line segments connected successively along a direction of the magnetic field as magnetic lines of force.
